(19) United States
(12) Patent Application Publication
(10) Pub. No.: US 2012/0156914 A1
(43) Pub. Date: Jun. 21, 2012

(54) ELECTRICAL CONNECTOR ASSEMBLY WITH AN ANTI-MISMATING MECHANISM

(75) Inventor: SU-FENG LIU, Kunshan (CN)

(73) Assignee: HON HAI PRECISION INDUSTRY CO., LTD., New Taipei (TW)

(21) Appl. No.: 13/329,316

(22) Filed: Dec. 18, 2011

(30) Foreign Application Priority Data
Dec. 17, 2010 (CN) 201010593792.X

(51) Int. Cl. H01R 13/62

(52) U.S. Cl. 439/344

(57) ABSTRACT

An electrical connector assembly (100), comprising a plug connector (30) and a receptacle connector (10) mating with each other, the plug connector comprises an insulative housing (31), a plurality of contacts (40) and a plurality of wires (50). The insulative housing comprises a base portion (310) with a latch member (32) and a plurality of mating posts (312). The latch member comprises a press portion (320), a supporting portion (321) and a linking portion (322), a beam portion (323) is defined on a front end of the linking portion, and defines a pair of doorjambs (3230, 3231) assembled to a top wall of the receptacle connector, and a pair of block walls (104, 105) are defined on a bottom wall.

### BACKGROUND OF THE INVENTION

1. Field of the Invention

The present invention generally relates to an electrical connector assembly, and more particularly to an electrical connector assembly with an anti-mismating mechanism.

2. Description of Related Art

CN patent No. 2689526Y discloses a plug connector comprising an insulated housing, a plurality of contacts received in the insulated housing, and a plurality of wires electrically connected with the contacts. The insulative housing has a front surface, a rear surface opposite to the front surface, a pair of lateral surfaces, and a plurality of mating posts extending forwards from the front surface. The insulative housing defines a pair of latching arms connected with lateral surfaces. While the plug connector mating with a complementary connector, the latching arms are locked with a pair of wedges on both sides of the complementary connector to prevent the two connectors depart from each other.

However, as the plug connector is symmetrical relative to a horizontal axis, the plug connector may be mismatched with the complementary connector.

Hence, it is desirable to have an improved structure to overcome the above-mentioned disadvantages of the prior art.

### BRIEF SUMMARY OF THE INVENTION

Accordingly, the object of the present invention is to provide an electrical connector assembly with an anti-mismating mechanism.

In order to achieve the above-mentioned object, an electrical connector assembly in accordance with the present invention comprises a plug connector and a receptacle connector mated with the plug connector, the plug connector comprises an insulative housing, a plurality of contacts received in the insulative housing and a plurality of wires electrically connected with the contacts. The insulative housing comprises a base portion and a plurality of mating posts extending forwards from a front surface of the base portion along a mating direction, the base portion defines a latch member on an upper surface thereof, and the latch member is formed unitarily with the base portion. The receptacle connector comprises an insulator. The latch member comprises a press portion, a supporting portion connected with the press portion and served as a pivot, and a linking portion extending forwards from the supporting portion, a beam portion is defined on a front end of the linking portion, and extending along a transverse direction, the beam portion defines a pair of doorjambs on both sides thereof, the doorjambs are assembled to a top wall of the receptacle connector, and a pair of block walls are defined on a bottom wall preventing the beam portion being assembled to.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled, perspective view of an electrical connector assembly in accordance with the present invention;

FIG. 2 is an exploded, perspective view of the electrical connector assembly shown in FIG. 1;

FIG. 3 is a view similar to FIG. 2, but viewed from a different aspect;

FIG. 4 is an assembled, perspective view of a plug connector of the electrical connector assembly;

FIG. 5 is a partially assembled, perspective view of the electrical connector assembly shown in FIG. 3; and

FIG. 6 is a cross-section view taken along line 6-6 of FIG. 1.

### DETAILED DESCRIPTION OF THE INVENTION

Reference will now be made to the drawing figures to describe the present invention in detail.

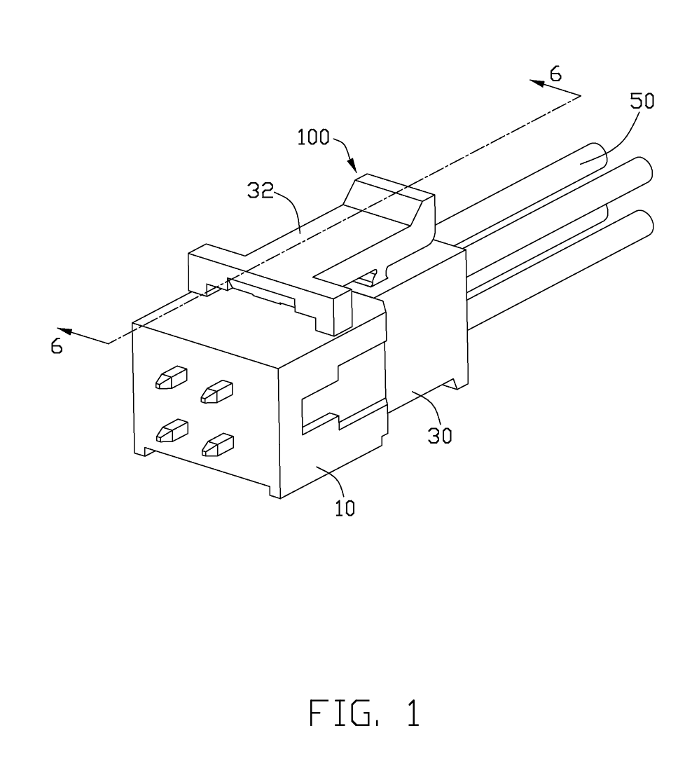

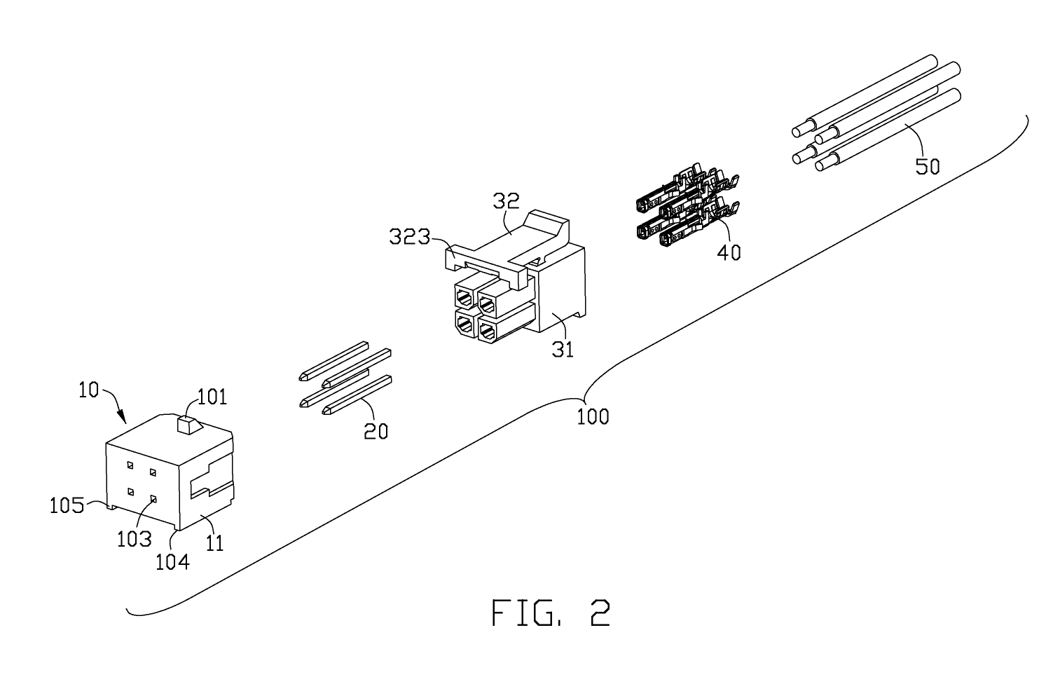

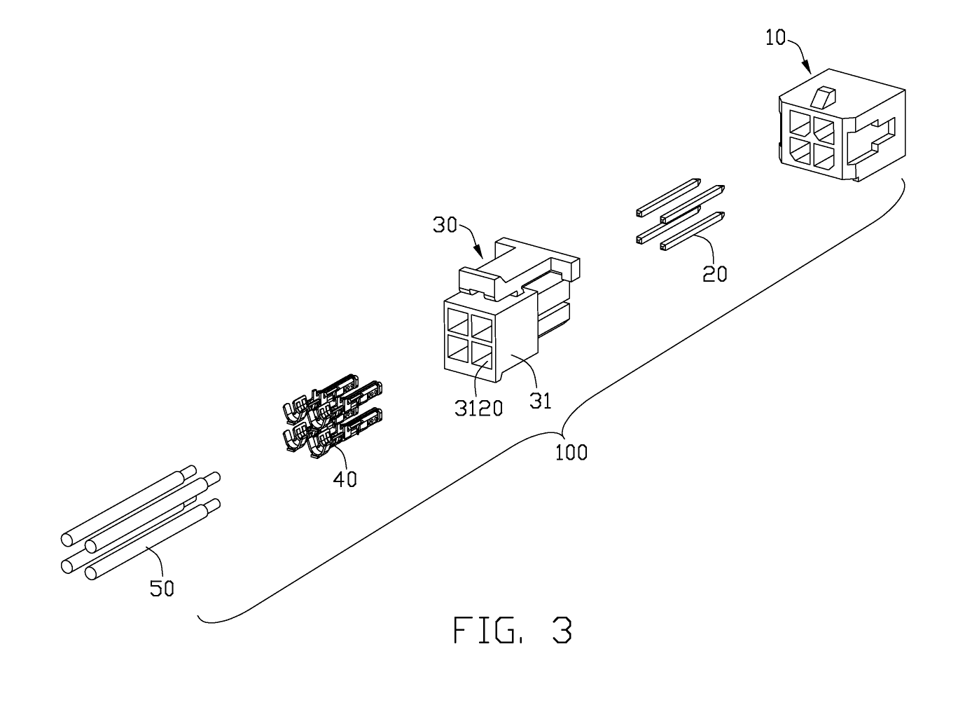

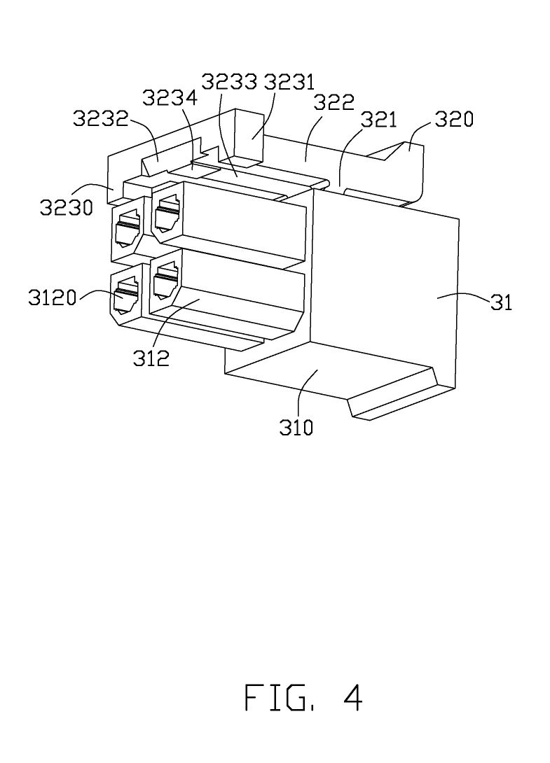

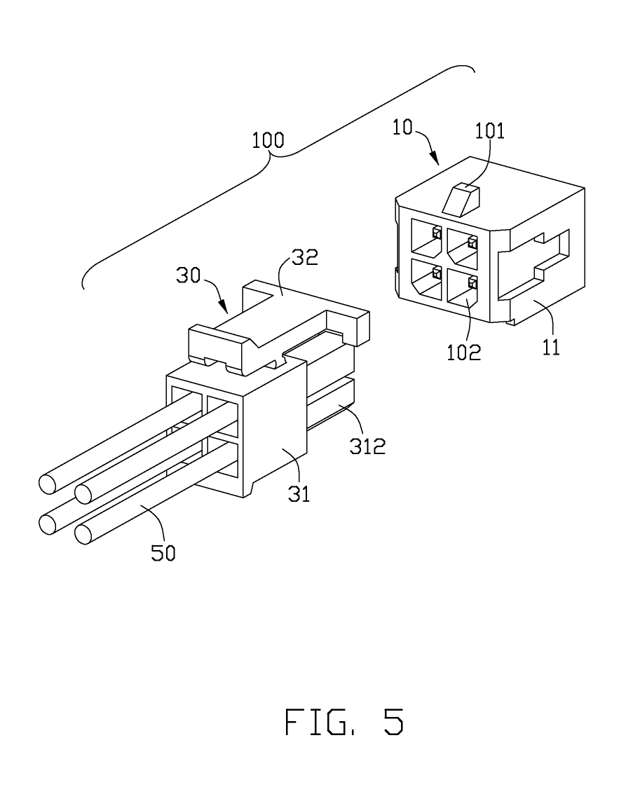

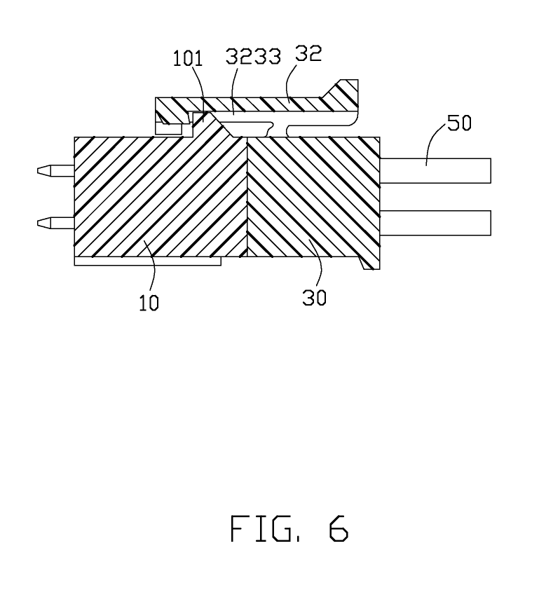

Referring to FIGS. 1-6, an electrical connector assembly 100 made in accordance with the present invention includes a plug connector 30 and a receptacle connector 10 mating with the plug connector 30, and the plug connector 30 comprises an insulative housing 31, a plurality of contacts 40 received in the insulative housing 31 and a plurality of wires 50 electrically connected with the contacts 40. The receptacle connector 10 comprises an insulator 11 and a number of contacts 20 received in the insulator 11.

The insulative housing 31 of the plug connector 30 comprises a base portion 310 and a plurality of mating posts 312 extending forwards from a front surface of the base portion 310 along a mating direction, the mating posts 312 are spaced apart from each other. The base portion 310 defines a number of passageways 3120 penetrating through a front surface thereof and the mating posts 312. The mating posts 312 are divided into a top row and a bottom row, and the mating posts in each row are symmetrical along a vertical axis. The mating posts 312 have at least two different cross-section views. The base portion 310 defines a latch member 32 on an upper surface thereof, the latch member 32 is formed unitarily with the base portion 310. The latch member 32 comprises a press portion 320, a supporting portion 321 connected with the press portion 320 and served as a pivot, and a linking portion 322 extending forwards from the supporting portion 321. A beam portion 323 is defined on a front end of the linking portion 322, and extending along a transverse direction. The beam portion 323 defines a pair of doorjambs 3230, 3231 on both sides thereof, and a wedge-shaped indentation 3232 is disposed on a front end of the beam portion 323. An elongate slot 3233 is defined on a bottom surface of the latch member 32, and a stopping portion 3234 is disposed between the slot 3233 and the indentation 3232.

The insulator 11 of the receptacle connector 10 defines a plurality of cavities 102 receiving the mating posts 312 of the plug connector 30. The insulator 11 defines a front wall, a top wall, a bottom wall opposite to the top wall and a rear wall. The front wall defines a plurality of holes 103 communicated with the corresponding cavities 102, for the contacts 20 being inserted through. The top wall defines a wedge 101 on a rear segment thereof to lock with the slot 3233, the bottom wall defines a pair of block walls 104, 105 preventing the beam portion 323 being assembled to. The block wall 104 has a larger height than the distance between the doorjamb 3230 and the top wall.

In assembly, the mating posts 312 of the plug connector 30 are inserted into the cavities 102 of the receptacle connector 10, the beam portion 323 of the latch member 32 is assembled to the top wall of the receptacle connector 10, and the doorjambs 3230, 3231 are close to the top wall of the receptacle connector 10. The wedge 101 of the receptacle connector 10 is guided by the indentation 3232 of the plug connector 30 and then sliding into slot 3233, the stopping portion 3234 can prevent the wedge 101 moving back from the slot 3233, thus can prevent the receptacle connector 10 being separated from the plug connector 30. While the plug connector 30 disengaging away from the receptacle connector 10, just exert a pressing force on the press portion 320 of the plug connector 30, to promote the beam portion 323 moving upwards, and the stopping portion 3234 is moving upwards at the same time, then the wedge 101 can be detached from the slot 3233 and the indentation 3232. If the plug connector 30 mismatched with the plug connector 10 reversely, the block walls 104, 105 on the bottom wall of the receptacle connector 10 can prevent the doorjambs 3230, 3231 moving.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
a plug connector comprising an insulative housing, a plurality of contacts received in the insulative housing and a plurality of wires electrically connected with the contacts, the insulative housing comprising a base portion and a plurality of mating posts extending forwards from a front surface of the base portion along a mating direction, the base portion defining a latch member on an upper surface thereof, and the latch member formed unitarily with the base portion; and
a receptacle connector mated with the plug connector and comprising an insulator, the insulator having a front wall, a top wall, a bottom wall opposite to the top wall and a rear wall;
wherein the latch member comprises a press portion, a supporting portion connected with the press portion and served as a pivot, and a linking portion extending forwards from the supporting portion, a beam portion is defined on a front end of the linking portion, and extending along a transverse direction, the beam portion defines a pair of doorjambs on both sides thereof, the doorjambs are assembled to the top wall, and the bottom wall defines a pair of block walls preventing the beam portion being assembled to.

2. The electrical connector assembly as claimed in claim 1, wherein a wedge-shaped indentation is disposed on a front end of the beam portion.

3. The electrical connector assembly as claimed in claim 1, wherein an elongate slot is defined on a bottom surface of the latch member, the top wall of the receptacle connector defines a wedge on a rear segment thereof to lock in the slot.

4. The electrical connector assembly as claimed in claim 1, wherein the base portion defines a number of passageways penetrating through a front surface thereof and the mating posts.

5. The electrical connector assembly as claimed in claim 1, wherein the mating posts have at least two different cross-section views.

6. The electrical connector assembly as claimed in claim 1, wherein the insulator of the receptacle connector defines a plurality of cavities receiving the mating posts of the plug connector.

7. The electrical connector assembly as claimed in claim 1, wherein the receptacle connector has a plurality of contacts received therein to mate with the contacts of the plug connector.

8. The electrical connector assembly as claimed in claim 1, wherein each block wall has a larger height than the distance between the doorjamb and the top wall.

9. A plug connector, comprising:
an insulative housing defining a base portion and a plurality of mating posts extending forwards from a front surface of the base portion along a mating direction, the base portion defining a latch member on an upper surface thereof, and the latch member formed unitarily with the base portion,
a plurality of contacts received in the insulative housing; and
a plurality of wires electrically connected with the contacts;
wherein the latch member comprises a press portion, a supporting portion connected with the press portion and served as a pivot, and a linking portion extending forwards from the supporting portion, a beam portion is defined on a front end of the linking portion, and extending along a transverse direction, the beam portion defines a pair of doorjambs on both sides thereof.

10. The plug connector as claimed in claim 9, wherein an elongate slot is defined on the latch member, a wedge-shaped indentation is disposed on a front end of the beam portion, and a stopping portion is disposed between the slot and the indentation.

11. An electrical connector assembly comprising:
a first connector including a first insulative housing defining a plurality of side walls with cavities therein;
a plurality of first contacts disposed in the corresponding cavities, respectively;
a second connector including a second insulative housing defining a plurality of hollow columns to be received in the corresponding cavities, respectively;
a plurality of second contacts disposed in the corresponding hollow columns, respectively, and mechanically and electrically connected to the corresponding first contacts, respectively;
a locking wedge block formed on an exterior surface of one of said side walls; and
a deflectable latch member formed on one exterior face of the second housing with, in a front-to-back direction, a rear fulcrum point behind the hollow columns and a front locking head above the hollow columns; wherein
a beam portion transversely formed on a locking head with pair of doorjambs which are respectively located at two opposite ends in a transverse direction perpendicular to said front-to-back direction, and extend toward the hollow columns in a vertical direction perpendicular to both said front-to-back direction and said transverse direction.

12. The electrical connector assembly as claimed in claim 11, wherein the second housing defines a pair of blocks on another exterior face of the second housing opposite to said exterior face so as to hinder the pair of doorjambs during wrong orientation between the first connector and the second connector during mating.
